(19) United States
(12) Patent Application Publication
(10) Pub. No.: US 2008/0265523 A1
(43) Pub. Date: Oct. 30, 2008

(54) Asymmetric Gasket

(75) Inventor: Andrew A. Galpin, Nashua, NH (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 11/742,000

(22) Filed: Apr. 30, 2007

(51) Int. Cl. F16J 15/02

(52) U.S. Cl. 277/590

(57) ABSTRACT

The asymmetric gasket counteracts the twisting tendency of a gasket in radiused portions. The design also energizes the seal in higher pressure applications to further increase the seal force and uniformity. The result is the minimization of potential for gasket roll and maximized seal pressure and stability. The gasket includes a gasket body having an upper surface and a lower surface each adapted to engage one of the two members being sealed. The gasket body has a radiused portion having an asymmetric cross section wherein the intermediate portion of the outboard surface extends radially outward from the outboard edges of the upper and lower surfaces to a greater extent than the intermediate portion of the inboard surface extends radially inward from the inboard edges of the upper and lower surfaces.

### FIELD

The present disclosure relates to gaskets for sealing between two members and more particularly, to a gasket having an asymmetric cross section for withstanding internal pressures.

### BACKGROUND AND SUMMARY

The statements in this section merely provide background information related to the present disclosure and may not constitute prior art.

Gaskets are commonly used for sealing an interface between two static members. The gaskets can be subjected to internal pressures such as in a coolant assembly, high pressure oil assembly, and fuel passageways. The gaskets are often pressed in place in a recessed groove in one of the members and compressed when the other member is fastened to the first. The standard cross section for this application is a symmetrical barrel design which is ideal in plane strain compression without internal pressures. When a symmetric section is compressed while turning a radius, the seal force becomes uneven and tends to lean to the outside of the application, which is referred to as hoop stress. Under internal pressure, this trend is exaggerated and the seal becomes even less robust.

The asymmetric gasket of the present disclosure counteracts the twisting tendency of the gasket in the radiused portions. The design also energizes the seal in higher pressure applications to further increase the seal force and uniformity. The result is the minimization of potential for gasket roll and maximized seal pressure and stability.

The asymmetric gasket is provided with a larger volume of material on the outboard side of the gasket. This creates a more uniform seal force as the gasket is compressed to counter the effects of hoop stress. The extra material also energizes as internal pressure increases to combat any potential for instability in high pressure applications.

The gasket of the present disclosure includes a gasket body having an upper surface and a lower surface each adapted to engage one of the two members. The upper surface and the lower surface each include an inboard edge and an outboard edge. The gasket body has a continuous closed loop inboard surface extending between the inboard edges of the upper surface and the lower surface and a continuous outboard surface extending between the outboard edges of the upper surface and the lower surface. The inboard surface includes an intermediate portion between the inboard edge of the upper surface and the inboard edge of the lower surface, the intermediate portion of the inboard surface extending radially inward from the inboard edges of the upper and lower surfaces. The outboard surface includes an intermediate portion between the outboard edge of the upper surface and the outboard edge of the lower surface. The intermediate portion of the outboard surface extending radially outward relative to the outboard edges of the upper and lower surfaces. The gasket body has a radiused portion having an asymmetric cross section wherein the intermediate portion of the outboard surface extends radially outward from the outboard edges of the upper and lower surfaces to a greater extent than the intermediate portion of the inboard surface extends radially inward from the inboard edges of the upper and lower surfaces.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a top plan view of an asymmetric gasket according to the principles of the present disclosure;

FIG. 2 is a cross-sectional view taken along line 2-2 of FIG. 1;

FIG. 3 is a cross-sectional view taken along line 3-3 of FIG. 1;

FIG. 4 is a cross-sectional view of a recessed groove for receiving the gasket according to the principles of the present disclosure;

FIG. 5 illustrates the results of a finite element analysis of the pressure distribution on a standard prior art symmetric gasket without internal pressure;

FIG. 6 illustrates the results of a finite element analysis of the pressure distribution on a standard prior art symmetric gasket with an internal pressure applied;

FIG. 7 illustrates the asymmetric gasket received in a recess groove prior to installation of an upper member according to the principles of the present disclosure;

FIG. 8 illustrates a finite element analysis of the pressure distribution on the asymmetric gasket according to the principles of the present disclosure, with no internal pressure applied;

FIG. 9 illustrates a finite element analysis of the pressure distribution on the asymmetric gasket with an internal pressure applied thereto;

FIG. 10 is a top plan view of a gasket having an asymmetric cross-section in the radiused region according to the principles of the present disclosure;

FIG. 11 is a cross-sectional view of the gasket of FIG. 10 taken along line 11-11 of FIG. 10; and

FIG. 12 is a cross-sectional view taken along line 12-12 of FIG. 10.

### DETAILED DESCRIPTION

The following description is merely exemplary in nature and is not intended to limit the present disclosure, application, or uses. It should be understood that throughout the drawings, corresponding reference numerals indicate like or corresponding parts and features.

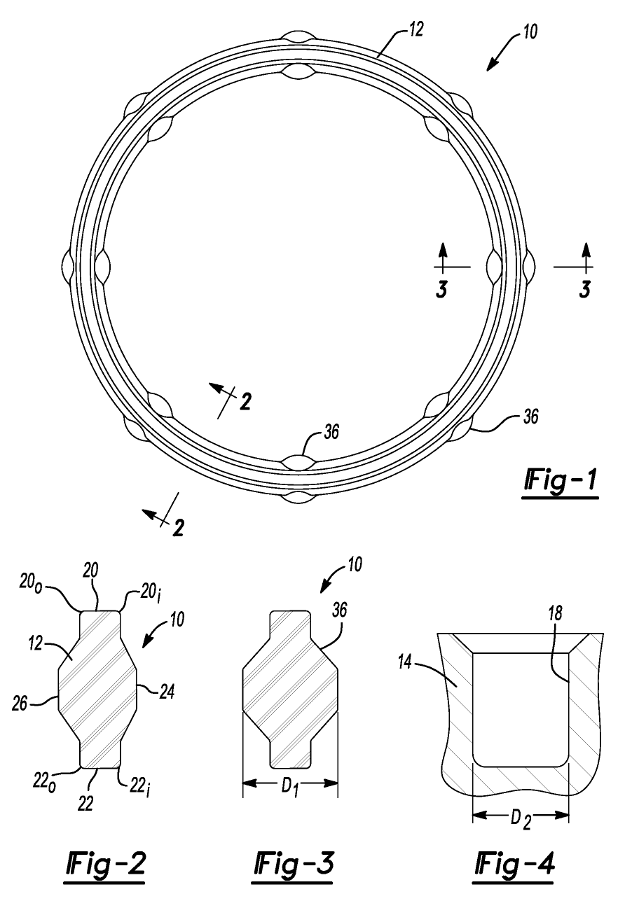

With reference to FIGS. 1-4 and 7-10, the asymmetric gasket 10, according to the principles of the present disclosure, will now be described. The asymmetric gasket 10 includes a gasket body 12 designed to seal between a first member 14 and a second member 16, as illustrated in FIG. 7. The first member 14 includes a recessed groove 18 that receives the gasket 10 therein. The second member 16 is secured to the first member 14 and compresses the gasket 10 within the recessed groove 18.

FIG. 2 illustrates a cross-section of the gasket 10 taken along line 2-2 of FIG. 1. As shown in FIG. 2, the gasket body 12 has an upper surface 20 and a lower surface 22 each adapted to engage one of the two members 14, 16. The upper surface 20 and lower surface 22 each include an inboard edge 20i, 22i, respectively, and an outboard edge 20o, 22o, respectively. The gasket body 12 has a continuous closed loop inboard surface 24 extending between the inboard edges 20i, 22i of the upper and lower surfaces 20, 22, respectively. The body 12 also includes a continuous outboard surface 26 extending between the outboard edges 20o, 22o of the upper surface 20 and lower surface 22, respectively. As best illustrated in FIG. 7, the inboard surface 24 includes an inwardly projecting intermediate portion 28 that extends from the inboard edges 20i, 22i of the upper and lower surfaces 20, 22. With further reference to FIG. 7, the outboard surface includes an outwardly projecting intermediate portion 30 between the outboard edge 20o of the upper surface 20 and the outboard edge 22o of the lower surface 22. The intermediate portion 30 of the outboard surface 26 extends radially outward relative to the outboard edges 20o, 22o of the upper surface 20 and the lower surface 22. The gasket body 12, as illustrated in FIG. 1, is a circular gasket wherein the entirety of the gasket body is radiused.

With reference to FIG. 7, the asymmetric gasket 10 is shown with the protruding intermediate portion 30 of the outboard surface 26 extending radially outward relative to the outboard edges 20o, 22o of the upper and lower surface 20, 22 by a distance X1 and the protruding intermediate portion 28 of the inboard surface 24 extends radially inward relative to the inboard edges 20i, 22i by a distance X2 as illustrated in FIG. 7. The distance X1 is greater than the distance X2. Thus, the gasket 10 is provided with a larger volume of material on the outboard side of the gasket. This creates a more uniform seal force as the gasket is compressed to counter the effects of hoop stress. The extra material also energizes as internal pressure increases to combat any potential for instability in high pressure applications.

The gasket body can include a plurality of retention features 36, as illustrated in FIG. 1. As illustrated in FIG. 3, a cross-sectional view taken along line 3-3 illustrates the cross-section of the retention features 36. The diameter D1 of the gasket 10 in the area of the retention feature 36 is designed to be greater than the diameter D2 of the recessed groove 18 provided in the first member 14. The retention features 36 properly locate the gasket 10 within the recess 18 prior to installation of the second member 16 to the first member 14.

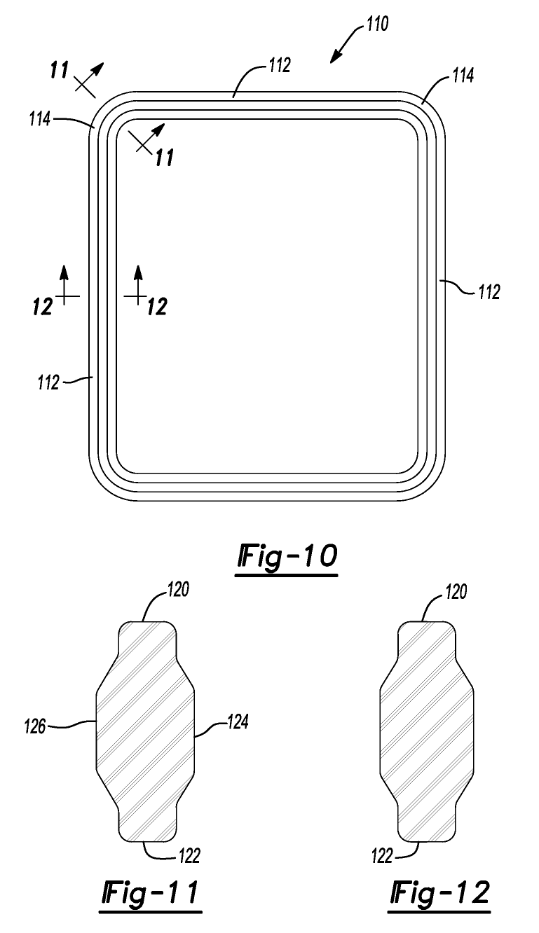

As illustrated in FIG. 10, the asymmetric gasket cross-section can also be utilized in radiused portions of a gasket that also includes straight sections therein. The gasket 110 shown in FIG. 10 includes straight sections 112 and radiused sections 114. The cross-section in the radiused sections is illustrated by FIG. 11 which is a cross-sectional view taken along line 11-11 of FIG. 10. As illustrated in FIG. 11, the radiused portions 114 are provided with an outboard surface 126 which extends radially outward to a greater extent than the radial inward protruding intermediate portion on the inboard surface 124 in the same manner as described above, with reference to FIGS. 1-4 and 7-9. The straight sections 112 can be provided with a symmetrical cross-section as illustrated in FIG. 12 such that the outboard and inboard surfaces are symmetrical to one another. It should be understood that the transition from a straight section 112 to a radius section 114 would provide for the intermediate portion of the outboard surface 126 extending radially outward relative to the outboard edges 120o, 122o of the upper and lower surfaces 120, 122 to an increasingly greater extent along the radiused portion from the at least one straight portion toward a mid-section of the radiused portion 114.

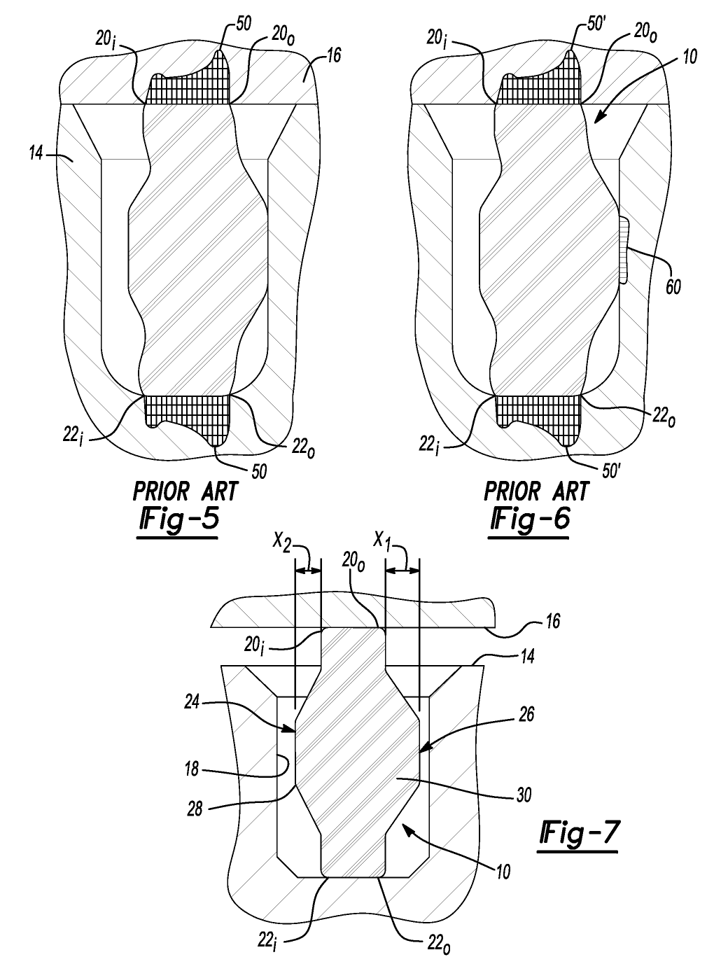

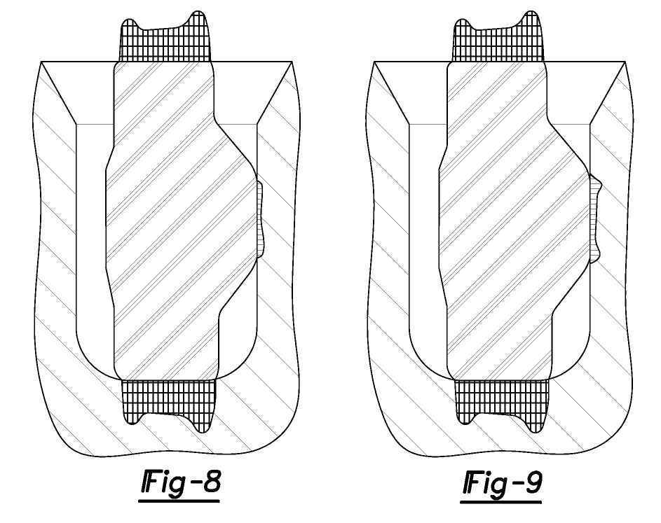

FIGS. 8 and 9 illustrate the improved sealing characteristics of an asymmetric gasket profile used in a radiused section of a gasket as compared to a symmetrical gasket profile. In particular, FIG. 5 illustrates finite element analysis of the force distribution of a symmetrical profiled gasket compressed between an upper member 16 and lower member 14 without any internal pressure being applied. As illustrated in FIG. 5, the outboard edges 20o, 22o are subjected to the highest pressure peaks 50 while a significant decrease in pressure is experienced in the radially inward direction toward the inboard edges 20i, 22i. FIG. 6 illustrates a finite element analysis of the force distribution on the symmetrical gasket of FIG. 5 being supplied with internal pressure such that the pressure distribution is still provided with pressure peak 50′ toward the outboard edge with reduced pressure distribution toward the inboard edge. The uneven force distribution is undesirable. In addition, the internal pressure causes the gasket 10 to press against the outer wall of the groove 18.

With reference to FIGS. 8 and 9, which illustrate the finite element analysis of the pressure distribution of the asymmetric gasket, it can be seen in FIG. 8 where no internal pressure is applied, the pressure distribution across the upper and lower surfaces 20, 22 is more evenly distributed as compared to the symmetric gasket design illustrated in FIG. 5. Similarly, as illustrated in FIG. 9 where internal pressure is applied to the same extent as the finite element analysis in FIG. 6, the asymmetric gasket provides a more even pressure distribution along the upper and lower surfaces 20, 22, thus providing a better seal engagement between the upper and lower members 14, 16. Thus, the design of the present disclosure improves the stability of the gasket as application pressure increases. The concept can be varied to accommodate any gasket centerline and can be fully integrated into a design in a round centerline gasket or only partially used in a gasket that is mostly straight with a few sharp corners.

The design of the present invention also has no affect on the retention features or gasket installation. The asymmetric feature of the gasket does not increase the cost or complexity for manufacturing the gaskets, and yet provides significant benefits for providing improved sealing characteristics in radiused portions of gaskets.

1. A gasket for sealing between two members comprising:
a gasket body having an upper surface and a lower surface each adapted to engage one of the two members, said upper surface and said lower surface each including an inboard edge and an outboard edge, said gasket body having a continuous closed loop inboard surface extending between the inboard edges of said upper surface and said lower surface and a continuous outboard surface extending between the outboard edges of said upper surface and said lower surface, said inboard surface including an intermediate portion between said inboard edge of said upper surface and said inboard edge of said lower surface, said intermediate portion of said inboard surface extending radially inward from said inboard edges of said upper and lower surface, said outboard surface including an intermediate portion between said outboard edge of said upper surface and said outboard edge of said lower surface, said intermediate portion of said outboard surface extending radially outward from said outboard edges of said upper and lower surfaces, ;and
a plurality of retention features extending from said gasket body,
wherein said gasket body has a radiused portion including retention feature portions where said retention features extend from said gasket body and non-retention feature portions where said retention features do not extend from said gasket body, wherein in said non-retention feature portions said intermediate portion of said outboard surface extends radially outward from said outboard edges of said upper and lower surfaces to a greater extent than said intermediate portion of said inboard surface extends radially inward from said inboard edges of said upper and lower surfaces.

2. The gasket according to claim 1, wherein said gasket body is circular.

3. (canceled)

4. The gasket according to claim 1, wherein said gasket body has a wider cross section than a remainder of said gasket body at said locations of said retention features.

5. (canceled)

6. A sealing system comprising:
a first member including a recessed groove;
a gasket body disposed in said recessed groove and having an upper surface and a lower surface, said lower surface engaging a lower surface of said recessed groove, said upper surface and said lower surface each including an inboard edge and an outboard edge, said gasket body having a continuous closed loop inboard surface extending between the inboard edges of said upper surface and said lower surface and a continuous outboard surface extending between the outboard edges of said upper surface and said lower surface, said inboard surface including an intermediate portion between said inboard edge of said upper surface and said inboard edge of said lower surface, said intermediate portion of said inboard surface extending radially inward from said inboard edges of said upper and lower surface, said outboard surface including an intermediate portion between said outboard edge of said upper surface and said outboard edge of said lower surface, said intermediate portion of said outboard surface extending radially outward from said outboard edges of said upper and lower surfaces,
a plurality of retention features extending from said gasket body, and
a second member secured to said first member and disposed against said upper surface of said gasket body
wherein said gasket body has a radiused portion including retention feature portions where said retention features extend from said gasket body and non-retention feature portions where said retention features do not extend from said gasket body, wherein in said non-retention feature portions said intermediate portion of said outboard surface extends radially outward from said outboard edges of said upper and lower surfaces to a greater extent than said intermediate portion of said inboard surface extends radially inward from said inboard edges of said upper and lower surfaces.

7. The sealing system according to claim 6, wherein said recessed groove and said gasket body are circular.

8. (canceled)

9. The sealing system according to claim 6, wherein said gasket body has a cross section having a width greater than a width of said recessed groove and wider than a remainder of said gasket body at said locations of said retention features.

10. (canceled)

11. A gasket for sealing between two members comprising:
a gasket body having an upper surface and a lower surface each adapted to engage one of the two members, said upper surface and said lower surface each including an inboard edge and an outboard edge, said gasket body having a continuous closed loop inboard surface extending between the inboard edges of said upper surface and said lower surface and a continuous outboard surface extending between the outboard edges of said upper surface and said lower surface, said inboard surface including an intermediate portion between said inboard edge of said upper surface and said inboard edge of said lower surface, said intermediate portion of said inboard surface extending radially inward from said inboard edges of said upper and lower surface, said outboard surface including an intermediate portion between said outboard edge of said upper surface and said outboard edge of said lower surface, said intermediate portion of said outboard surface extending radially outward from said outboard edges of said upper and lower surfaces, said gasket body having a plurality of radiused portions having an asymmetric cross section wherein said intermediate portion of said outboard surface extends radially outward from said outboard edges of said upper and lower surfaces to a greater extent than said intermediate portion of said inboard surface extends radially inward from said inboard edges of said upper and lower surfaces, and a plurality of straight portions having a symmetric cross-section along an entire length thereof that each connect said plurality of radiused portions such that said intermediate portion of said outboard surface of said plurality of straight portions extends radially outward from said outboard edges of said upper and lower surfaces to the same extent that said intermediate portion of said inboard surface of said plurality of straight portions extends radially inward from said inboard edges of said upper and lower surfaces.

12. The gasket according to claim 11, wherein said intermediate portion of said outboard surface extends radially outward relative to said outboard edges of said upper and lower surfaces to an increasingly greater extent along said radiused portion from said at least one straight portion to a mid-section of said radiused portion.

13. A sealing system comprising:
a first member including a recessed groove;
a gasket body disposed in said recessed groove and having an upper surface and a lower surface, said lower surface engaging a lower surface of said recessed groove, said upper surface and said lower surface each including an inboard edge and an outboard edge, said gasket body having a continuous closed loop inboard surface extending between the inboard edges of said upper surface and said lower surface and a continuous outboard surface extending between the outboard edges of said upper surface and said lower surface, said inboard surface including an intermediate portion between said inboard edge of said upper surface and said inboard edge of said lower surface, said intermediate portion of said inboard surface extending radially inward from said inboard edges of said upper and lower surface, said outboard surface including an intermediate portion between said outboard edge of said upper surface and said outboard edge of said lower surface, said intermediate portion of said outboard surface extending radially outward from said outboard edges of said upper and lower surfaces, said gasket body having a plurality of radiused portions having an asymmetric cross section wherein said intermediate portion of said outboard surface extends radially outward from said outboard edges of said upper and lower surfaces to a greater extent than said intermediate portion of said inboard surface extends radially inward from said inboard edges of said upper and lower surfaces, and a plurality of straight portions having a symmetric cross-section along an entire length thereof that each connect said plurality of radiused portions such that said intermediate portion of said outboard surface of said plurality of straight portions extends radially outward from said outboard edges of said upper and lower surfaces to the same extent that said intermediate portion of said inboard surface of said plurality of straight portions extends radially inward from said inboard edges of said upper and lower surfaces; and
a second member secured to said first member and disposed against said upper surface of said gasket body.

14. The sealing system according to claim 13, wherein said intermediate portion of said outboard surface extends radially outward relative to said outboard edges of said upper and lower surfaces to an increasingly greater extent along said radiused portion from said at least one straight portion to a mid-section of said radiused portion.
